(19) United States
(12) Patent Application Publication
(10) Pub. No.: US 2026/0222695 A1
(43) Pub. Date: Jul. 30, 2026

(54) CODE READER SYSTEM AND CONTROLLER

(71) Applicant: Keyence Corporation, Osaka (JP)

(72) Inventors: Hiroyuki MAEDA, Osaka (JP); Hiroomi OHORI, Osaka (JP)

(73) Assignee: Keyence Corporation, Osaka (JP)

(21) Appl. No.: 19/417,398

(22) Filed: Dec. 12, 2025

(30) Foreign Application Priority Data
Jan. 24, 2025 (JP) 2025-010342

(51) Int. Cl. H04N 23/90

(52) U.S. Cl. CPC H04N 23/90

(57) ABSTRACT

To quickly reflect installation information to a replacement camera when replacing a camera that captures images of codes attached to workpieces, thereby expediting recovery. A controller 100 of a code reader system includes: a storage unit 112 that stores installation information of cameras; a control unit 107 that determines imaging conditions for multiple cameras based on the installation information stored in the storage unit 112; and a detection unit 111 that detects the removal of any of the cameras whose installation information is stored in the storage unit 112 and the connection of a new camera. The imaging conditions for the new camera are determined based on the installation information of the removed camera.

### CROSS-REFERENCE TO RELATED APPLICATIONS

The present application claims foreign priority based on Japanese Patent Application No. 2025-010342, filed January 24, 2025, the contents of which are incorporated herein by reference.

### BACKGROUND OF THE INVENTION

### 1. TECHNICAL FIELD

This disclosure relates to a code reader system and a controller that are used in, for example, logistics sites.

### 2. DESCRIPTION OF THE RELATED ART

For example, JP 2015-226324 A discloses a surveillance camera network configured by connecting multiple cameras. In the surveillance camera network of JP 2015-226324 A, when one camera constituting the surveillance camera network is replaced, the settings of the replacement camera are automatically performed.

Meanwhile, in logistics sites and other locations, workpieces conveyed by transport apparatus are managed by code readers that read codes attached to the workpieces.

Such code readers are equipped with cameras for capturing images of the workpieces. To achieve accurate code reading, the camera installation information relative to the workpiece is important, and the camera installation information is set in advance for each site.

However, when a camera is replaced for repair or maintenance, the installation information is not set in the camera after replacement, so after replacing the camera, work to apply the installation information to the post-replacement camera is necessary. During the period from camera replacement to recovery, especially in logistics sites, the conveyance of workpieces must be stopped, resulting in significant losses, so it is desirable to quickly apply the installation information to the camera after replacement.

In this regard, the network disclosed in JP 2015-226324 A is a surveillance camera network, and therefore it does not suggest issues arising from camera replacement in a logistics site, nor does it suggest the need to quickly apply installation information to a replacement camera, and it also does not suggest a configuration that enables quick application of installation information to a replacement camera.

### SUMMARY OF THE INVENTION

The present disclosure has been made in view of such points, and its purpose is to quickly reflect installation information to a camera after replacement and expedite recovery when a camera for capturing a code attached to a workpiece is replaced.

To achieve the above objective, one aspect of the present disclosure can be premised on a code reader system comprising one or more cameras that generate images based on reflected light from codes attached to workpieces conveyed on a conveyor, a decoder that executes decode processing of the codes attached to the workpieces based on images output from the one or more cameras, and a controller to which the one or more cameras and the decoder are connected.

The controller comprises a storage unit that stores installation information of each of the one or more cameras, a control unit that determines imaging conditions of the one or more cameras based on the installation information stored in the storage unit, and a detection unit that detects removal of any of the one or more cameras whose installation information is stored in the storage unit, and connection of a new camera different from the one or more cameras. The imaging conditions of the new camera can be determined based on the installation information of the removed camera.

According to this configuration, the imaging conditions of one or more cameras are determined by the controller, and when the camera captures an image of a workpiece being conveyed on the conveyor, decoding of the code attached to the workpiece is executed by the decoder based on the image output from the camera. When an existing camera is removed and a new camera is connected to the controller, this is detected by the detection unit. Since the imaging conditions of the new camera are automatically determined based on the installation information of the removed camera, operation using the new camera can be started quickly.

In another aspect of the present disclosure, it is also possible to assume a controller to which one or more cameras that generate images based on reflected light from a code attached to a workpiece conveyed on a conveyor, and a decoder that executes decode processing of the code attached to the workpiece based on images output from the one or more cameras, are connected.

The controller includes a storage unit that stores installation information for each of the one or more cameras, a control unit that determines imaging conditions for the one or more cameras based on the installation information, and a detection unit that detects removal of any of the one or more cameras for which installation information has been stored, and connection of a new camera different from the one or more cameras. The control unit can determine imaging conditions for the workpiece for the new camera based on the installation information of the removed camera.

As described above, when an existing camera is removed and a new camera is connected to the controller, the imaging conditions of the new camera are automatically determined based on the installation information of the removed camera, so that the installation information can be quickly reflected in the replaced camera, thereby expediting the recovery of the code reader system.

### BRIEF DESCRIPTION OF THE DRAWINGS

FIG. 1 is a schematic configuration diagram of a code reader system according to an embodiment of the present invention;

FIG. 2 is a diagram explaining an operation example 1 of the code reader system;

FIG. 3 is a plan view explaining an operation example 2 of the code reader system;

FIG. 4A is a plan view explaining an operation example 2 of the code reader system;

FIG. 4B is a side view explaining an operation example 2 of the code reader system;

FIG. 5 is a block diagram of the code reader;

FIG. 6 is a diagram showing the positional relationships from the trigger point to the output point;

FIG. 7A is a diagram showing an example of a configuration in which a controller and code readers are connected in a ring shape;

FIG. 7B is a diagram showing an example of a configuration in which a controller and code readers are connected in a linear shape;

FIG. 8 is a diagram explaining the positional relationship between the code reader and the transport apparatus;

FIG. 9 is a block diagram of the controller;

FIG. 10 is a flowchart showing the initial setting procedure of the code reader system;

FIG. 11 is a diagram showing an example of a setting screen for device registration;

FIG. 12 is a diagram showing an example of a device registration screen;

FIG. 13 is a diagram showing an example of a display screen for registered devices;

FIG. 14 is a flowchart showing the processing when device replacement is performed.

### DETAILED DESCRIPTION

Hereinafter, embodiments of the present invention will be described in detail with reference to the drawings. It should be noted that the description of the following preferred embodiments is essentially illustrative only and is not intended to limit the invention, its applications, or its uses. For example, the relative sizes and positional relationships of the various components shown in the figures are for describing one embodiment and do not limit the present invention.

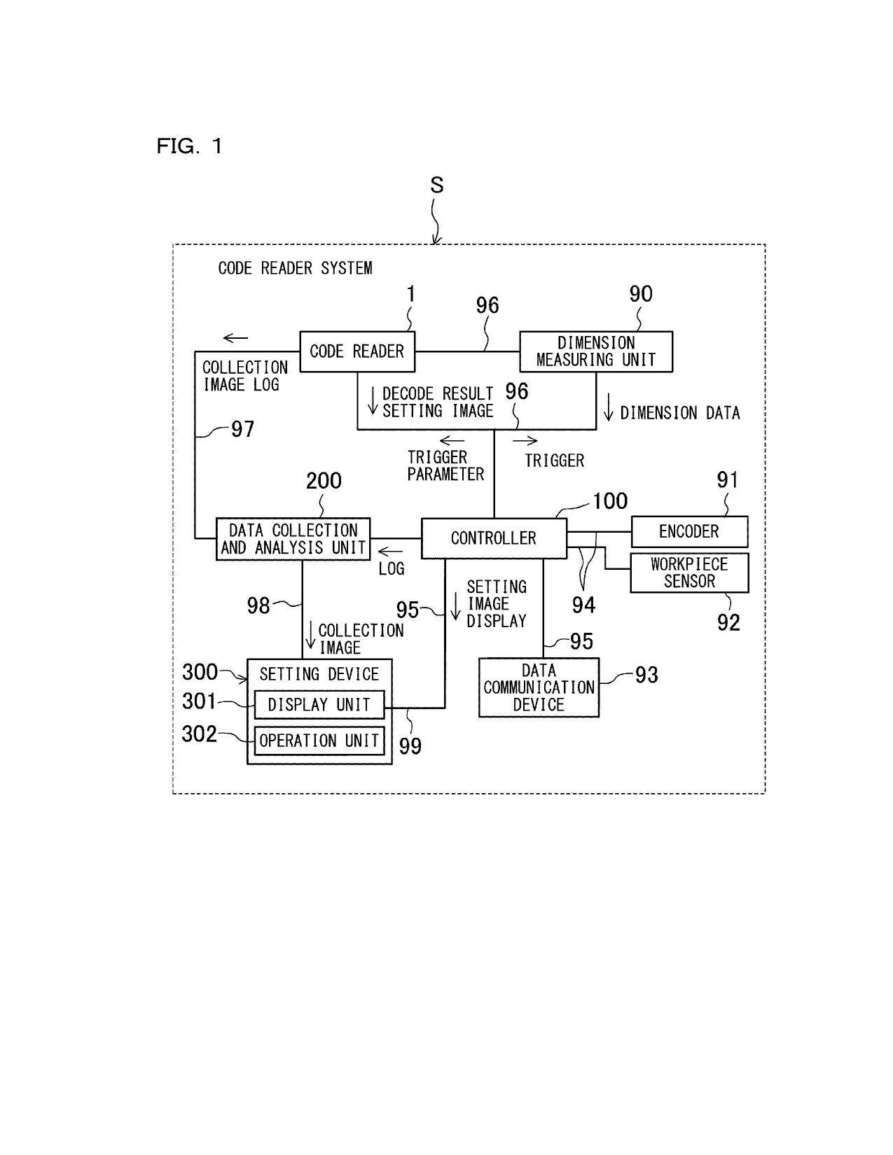

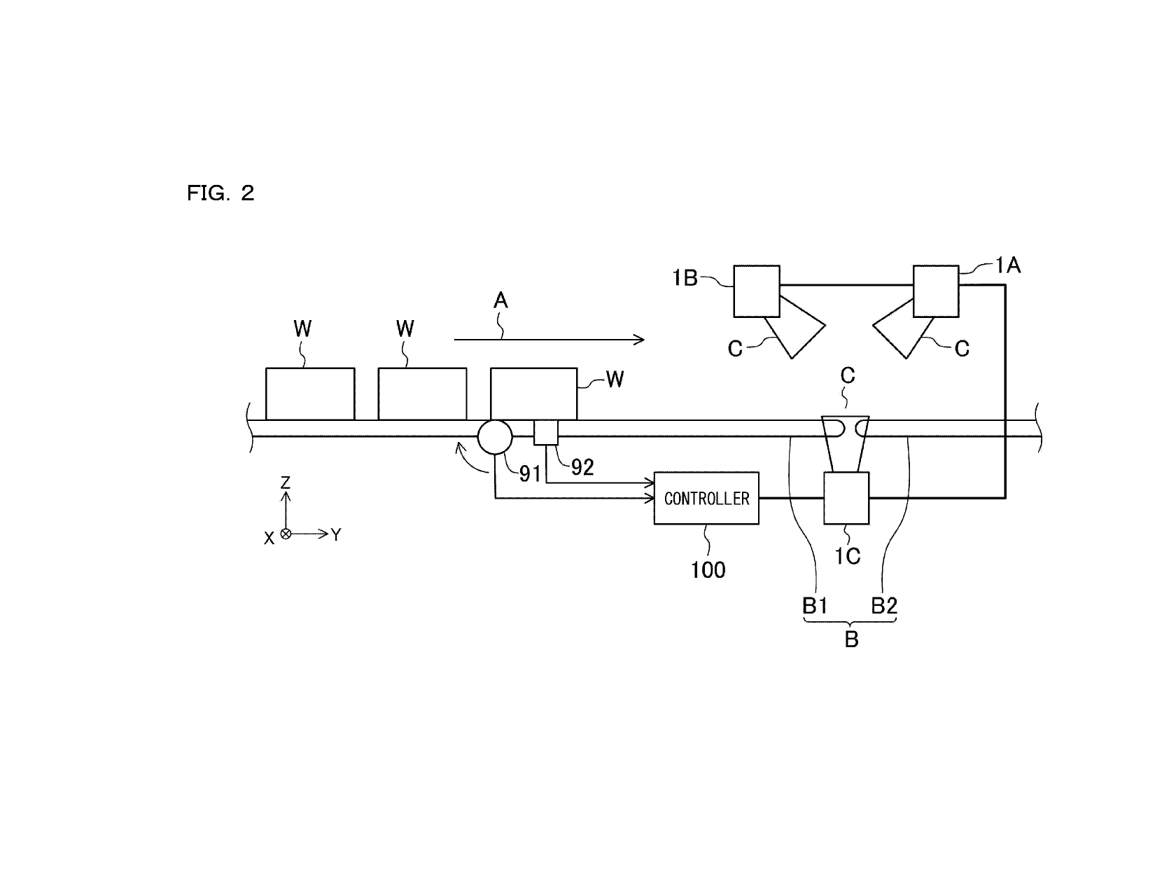

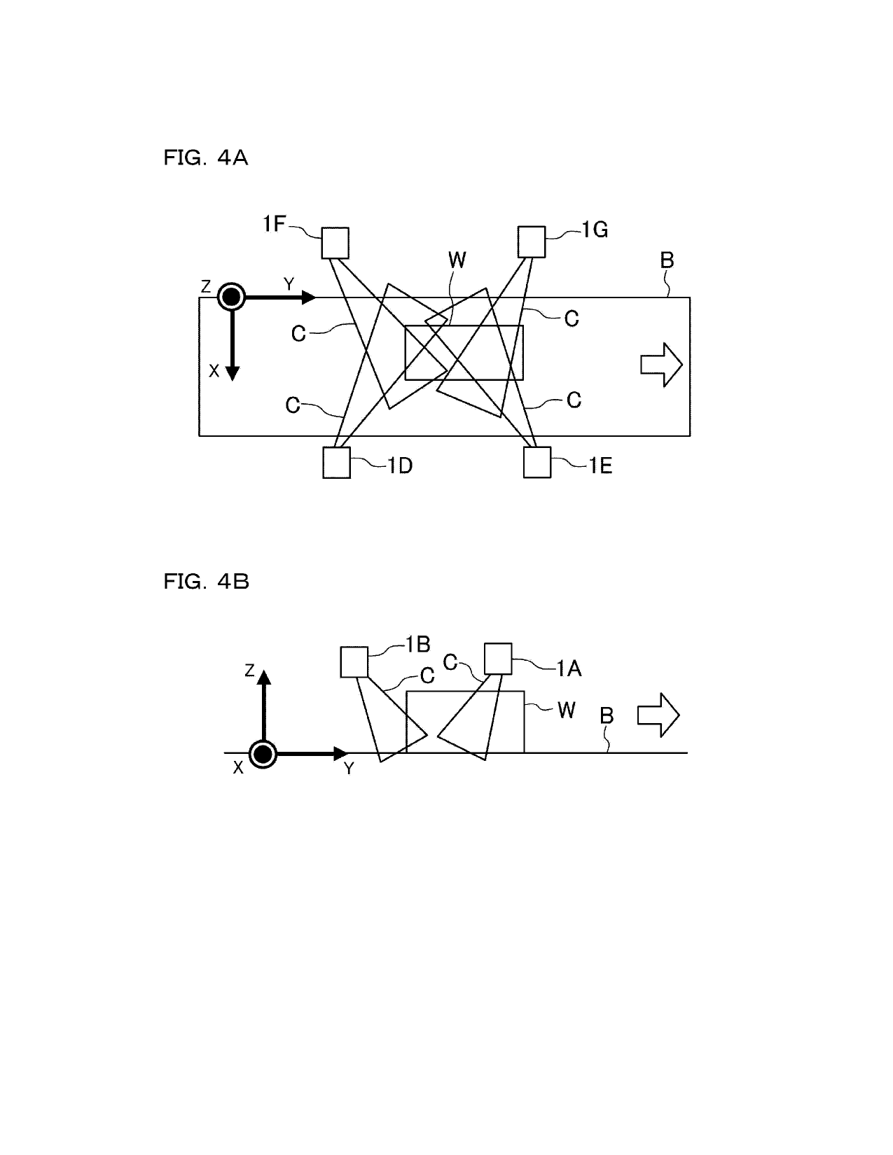

FIG. 1 is a diagram showing the schematic configuration of a code reader system S having a code reader 1 according to an embodiment of the present invention. FIGS. 2, 3, 4A, and 4B are diagrams explaining operation examples 1 and 2 of the code reader system S. These operation examples 1 and 2 show cases where the code reader system S is used in a logistics site handling multiple workpieces W. A transport apparatus B for sequentially conveying multiple workpieces W in a predetermined direction of conveyance is installed at the logistics site. The direction of conveyance of the workpieces W is indicated by arrow A in FIG. 2, and therefore the left side in FIGS. 2, 4A, and 4B is the upstream side in the direction of conveyance, and the right side is the downstream side in the direction of conveyance.

As shown in FIG. 2, the transport apparatus B includes a plurality of conveyor elements B1, B2. Each of the conveyor elements B1, B2 is constituted of, for example, a belt conveyor or a roller conveyor, and includes an upstream side conveyor element B1 and a downstream side conveyor element B2. The upper surfaces of the upstream side conveyor element B1 and the downstream side conveyor element B2 serve as the transport surface. In this embodiment, the direction of conveyance of the workpiece W is defined as the Y direction, the direction perpendicular to the Y direction on the transport surface is defined as the X direction, and the direction perpendicular to both the X direction and the Y direction is defined as the Z direction. At logistics sites, the X direction and Y direction are often approximately horizontal, but there are also cases where the Y direction is inclined with respect to the horizontal plane. The X direction can also be referred to as the width direction of the conveyor elements B1, B2, or it can be called the longitudinal direction of the gap of the transport apparatus B. Also, the Z direction can also be called the height direction (vertical direction). Note that this definition of directions is for convenience of explanation and does not limit the direction during use.

The upstream side conveyor element B1 and the downstream side conveyor element B2 are arranged with a gap in the direction of conveyance. The size (dimension) of the gap between the upstream side conveyor element B1 and the downstream side conveyor element B2 is not particularly limited, but is set so that the smallest workpiece W to be transported does not fall through the gap and is smoothly transferred from the upstream side conveyor element B1 to the downstream side conveyor element B2. The longitudinal dimension of the gap (X-direction dimension) is approximately the same as the width (X-direction dimension) of the conveyor elements B1, B2, but this is also not particularly limited.

The number of code readers 1 that the code reader system S has may be one or may be a plurality. The code reader 1 of this embodiment is a fixed type. The operation time of this fixed type code reader 1 is when it is performing the operation of sequentially reading codes of workpieces W conveyed by the transport apparatus B. The code reader 1 is fixed to a frame, stand, bracket, etc., which are not shown. In this embodiment, a case where the code reader system S has a plurality of code readers 1 will be described. In operation example 1 shown in FIG. 2, three code readers 1 are used, and the field of view range of each code reader 1 is indicated by code C.

In cases where there are multiple code readers 1, the multiple code readers 1 can be installed so as to surround the workpiece W. That is, the code reader 1 of operation example 1 includes an upstream oblique reading code reader 1A installed above the workpiece W to be capable of reading a code attached to the workpiece W from the upstream side, a downstream oblique reading code reader 1B installed above the workpiece W to be capable of reading a code attached to the workpiece W from the downstream side, and a bottom reading code reader 1C. The bottom reading code reader 1C is installed below the transport apparatus B such that the gap between the upstream conveyor element B1 and the downstream conveyor element B2 is included in the field of view C.

Since the gap between the upstream side conveyor element B1 and the downstream side conveyor element B2 is included in the field of view range C of the bottom reading code reader 1C, when the bottom surface of the workpiece W being transported passes through the gap, the bottom surface can be captured by the code reader 1C. A code may be attached to the bottom surface of the workpiece W. When a code is attached to the bottom surface of the workpiece W, since the code reader 1 is installed at an installation position below the transport surface of the transport apparatus B, the code attached to the bottom surface of the workpiece W can be read through the gap from below the transport surface of the transport apparatus B.

The imaging unit 3 of the bottom reading code reader 1C is a bottom camera that continuously captures the bottom surface of the workpiece W that is exposed through a gap in the transport apparatus B and included in the depth of field of the imaging unit 3, thereby outputting multiple images in which part of the code attached to the bottom surface of the workpiece W is captured. After multiple images in which part of the code in the direction of conveyance is captured are sequentially output from the image sensor 31b, a code image attached to the bottom surface of the workpiece W can be obtained by synthesizing these images.

Multiple code readers 1C for bottom reading can be installed. In this case, a configuration can be provided with multiple imaging units 3 that target the gap of a common conveyor apparatus B from below the transport surface of the conveyor apparatus B, and multiple illumination units 2 corresponding to these multiple imaging units 3.

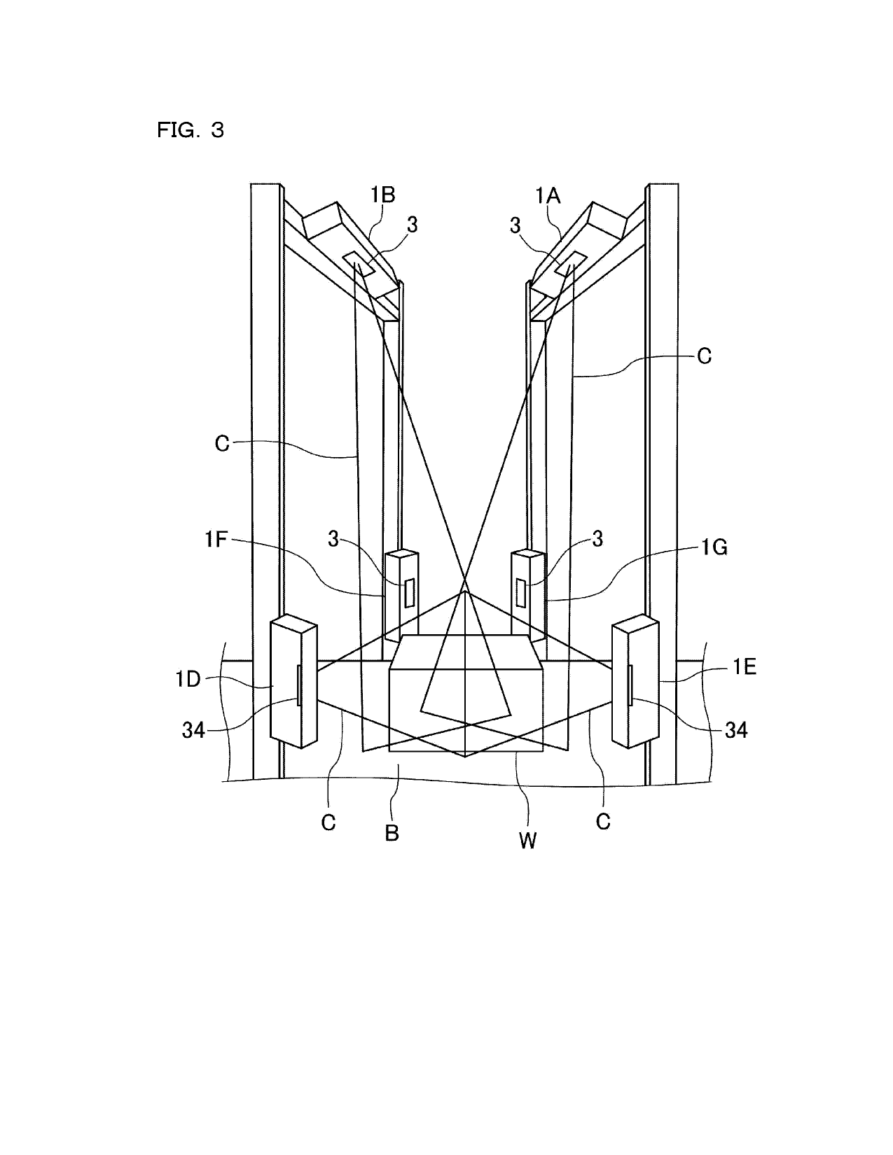

FIG. 3 shows the arrangement of code readers 1A, 1B, 1D, 1E, 1F and 1G in operation example 2. FIG. 4A shows a view of code readers 1D to 1G of operation example 2 as seen from above the conveyor B, and FIG. 4B shows a view of code readers 1A and 1B of operation example 2 as seen from the side of the conveyor B. In operation example 2, six code readers are used. Specifically, code reader 1A targets the upper surface and front surface of the workpiece W for imaging, code reader 1B targets the upper surface and rear surface of the workpiece W for imaging, code reader 1D targets the side surface (right side in the direction of conveyance) and rear surface of the workpiece W for imaging, code reader 1E targets the side surface (right side in the direction of conveyance) and front surface of the workpiece W for imaging, code reader 1F targets the side surface (left side in the direction of conveyance) and rear surface of the workpiece W for imaging, and code reader 1G targets the side surface (left side in the direction of conveyance) and front surface of the workpiece W for imaging.

The code reader system in this embodiment is not limited to operation examples 1-2, and operation examples 1 and 2 can be arbitrarily combined. For example, in operation example 2, the bottom-reading code reader 1C of operation example 1 may be additionally installed. The code reader 1 can also be installed at locations other than those in operation examples 1 and2. In operation examples 1 and 2, a plurality of code readers 1 can target mutually different workpiece surfaces of the same workpiece W for image capture.

The code attached to the workpiece W includes both barcode and two-dimensional code. As two-dimensional codes, there are, for example, QR code (registered trademark), Micro QR code, Data matrix (Data matrix; Data code), Veri code, Aztec code, PDF417, Maxi code, etc. Two-dimensional codes include stack type and matrix type, but the present invention can be applied to either type of two-dimensional code. The code may be attached by directly printing or engraving on the workpiece W, or by printing on a label and then attaching it to the workpiece W, and the means and method are not limited. Also, when using multiple code readers 1, they may all be the same code reader or may be different code readers. In the following description, all of them are assumed to be the same code reader 1.

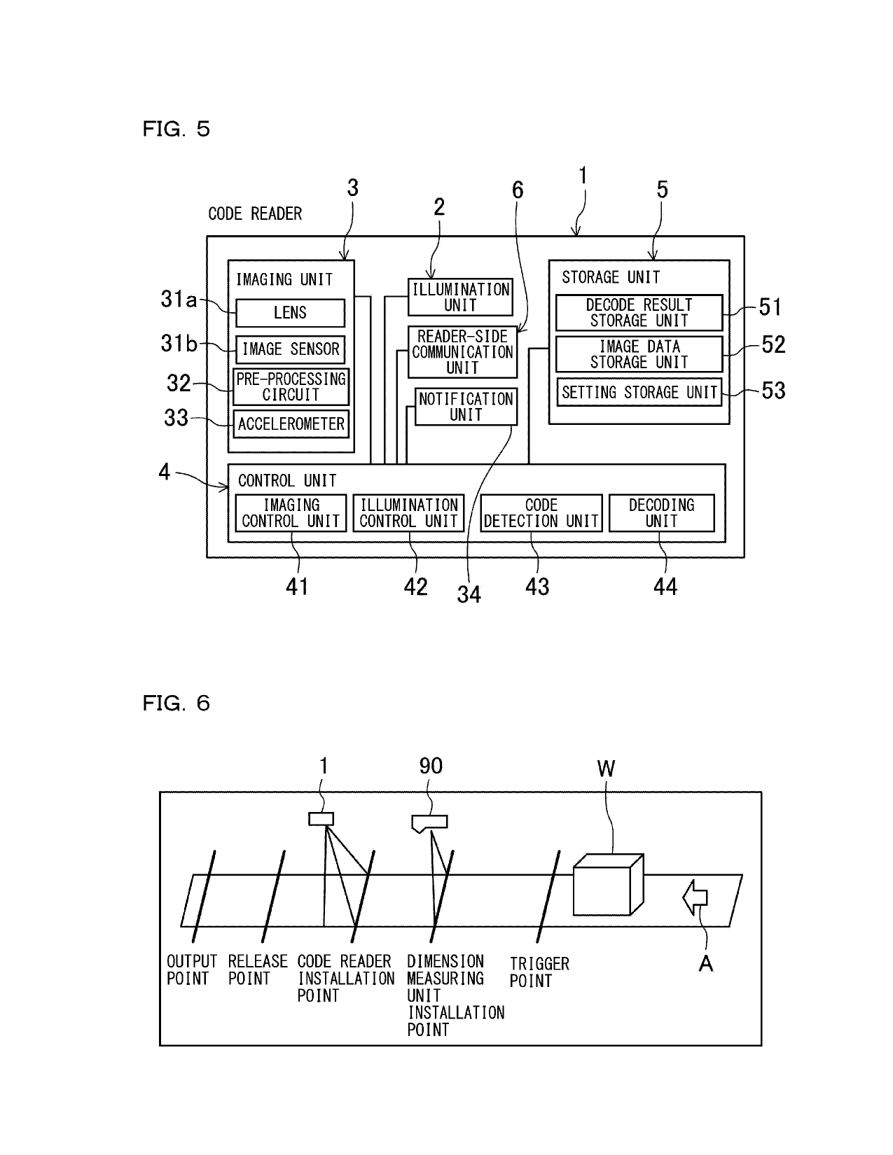

FIG. 5 is a block diagram of the code reader 1. The code reader 1 includes an illumination unit 2, an imaging unit (camera) 3, a control unit 4, a storage unit 5, and a reader-side communication unit 6. The control unit 4 includes an imaging control unit 41 that controls the imaging unit 3, an illumination control unit 42 that controls the illumination unit 2, a code detection unit 43, and a decoding unit (decoder) 44. Further, the storage unit 5 includes a decode result storage unit 51, an image data storage unit 52, and a setting storage unit 53. The decode result storage unit 51, the image data storage unit 52, and the setting storage unit 53 can be configured with readable and writable storage devices such as an SSD (Solid State Drive). Although not shown, the decode result storage unit 51, the image data storage unit 52, and the setting storage unit 53 may be provided in separate storage devices.

The reader-side communication unit 6 is a part that executes communication with various external devices (details will be described later). Setting information etc. sent from external devices is received by the control unit 4 via the reader-side communication unit 6. Also, the read start trigger signal from an external device is received by the control unit 4 via the reader-side communication unit 6. The decode result by the code reader 1 is sent to the external device via the reader-side communication unit 6. Also, the reader-side communication unit 6 receives, for example, the dimension of the gap formed between the plurality of conveyor elements B1, B2 that the transport apparatus B has, and the conveyance speed of the transport apparatus B, etc. The dimension of the gap and the conveyance speed can be input in advance by the user to the external device. The input dimension of the gap and conveyance speed are stored in the external device, and after the dimension of the gap and the conveyance speed are sent from the external device, the reader-side communication unit 6 receives and acquires them.

The illumination unit 2 is a part that irradiates illumination light to the workpiece W being transported on the transport apparatus B. In the operation example 1 shown in FIG. 2, since the bottom-reading code reader 1C is installed below the transport surface of the transport apparatus B, the illumination unit 2 irradiates illumination light from below the transport surface toward the gap between the upstream side conveyor element B1 and the downstream side conveyor element B2. As a result, when the bottom surface of the workpiece W being transported passes through the gap between the upstream side conveyor element B1 and the downstream side conveyor element B2, that bottom surface can be illuminated by the illumination unit 2. When a code is attached to the bottom surface of the workpiece W, the code attached to the bottom surface of the workpiece W can be illuminated by the illumination unit 2. The illumination unit 2 is equipped with a light emitting element such as, for example, a light emitting diode (LED: Light Emission Diode).

The illumination unit 2 and the imaging unit 3 may be integrated, or the illumination unit 2 and the imaging unit 3 may be separate bodies. The illumination unit 2 is controlled by the illumination control unit 42, and switching between illumination and non-illumination, or changing the brightness during illumination, etc., is performed. When a read start trigger signal is input from an external device, the illumination control unit 42 causes the illumination unit 2 to illuminate for a predetermined time, and turns off the illumination after the predetermined time has elapsed.

The imaging unit 3 is a part that generates an image based on reflected light from a code attached to a workpiece W being transported on the transport apparatus B. The imaging unit 3 can generate a code image containing the code by capturing an image of the workpiece W and output it to the control unit 4. The imaging unit 3 has a lens 31a, an image sensor 31b, and a preprocessing circuit 32. The lens 31a is an imaging lens that collects reflected light from the workpiece W. Light incident on the lens 31a is emitted toward the light receiving surface of the image sensor 31b and forms an image on the light receiving surface.

The image sensor 31b includes a light-receiving element such as a CCD (charge-coupled device) or CMOS (complementary metal oxide semiconductor) that converts the image of the code obtained through the lens 31a into an electrical signal. Based on the amount of light received on the light receiving surface of the image sensor 31b, an image containing the code is generated. The image sensor 31b has a plurality of imaging elements arranged in row and column directions, that is, a plurality of pixels arranged in a matrix. In other words, the imaging unit 3 is a so-called area camera. In this embodiment, the image sensor 31b has more pixels in the column direction (U direction) than in the row direction (V direction). Camera information related to the imaging unit 3, such as the number of pixels of the image sensor 31b, focal length, sensor size, etc., is stored in the storage unit 5. The captured image (hereinafter also simply referred to as "image") generated by the image sensor 31b by capturing the workpiece W etc. is input to the preprocessing circuit 32. The preprocessing circuit 32 may be set as needed and is not essential.

The preprocessing circuit 32 is configured with an integrated circuit such as FPGA (Field Programmable Gate Array) and is a part that executes various preprocessing on the image output from the image sensor 31b. The preprocessing includes, for example, various filter processing. The imaging unit 3 outputs an image that has been preprocessed by the preprocessing circuit 32 to the control unit 4. The preprocessing by the preprocessing circuit 32 may be executed as needed, and it is also acceptable to output an image that has not been preprocessed to the control unit 4. The image output to the control unit 4 is stored in the image data storage unit 52.

The imaging unit 3 is controlled through an imaging control unit 41 that is controlled by a control unit 107 of the controller 100 to be described later. When a read start trigger signal is input from an external device, the imaging control unit 41 generates an image by exposing for a predetermined exposure time. By the imaging control unit 41 controlling the imaging unit 3, it also executes processing that applies a predetermined gain to the image generated by the image sensor 31b and amplifies the brightness of the image through digital image processing.

The imaging unit 3 of the code reader 1 has an accelerometer 33. This accelerometer 33 can acquire the inclination, etc. of the imaging unit 3 or the code reader 1 with respect to the direction of gravity. The inclination with respect to the direction of gravity can be included in the installation information of the imaging unit 3 or the code reader 1.

Control unit 4 is a part that controls each part of the code reader 1, and based on a plurality of images output from imaging unit 3, detects a code attached to the workpiece W, and executes decode processing of the detected code. As a specific configuration example of control unit 4, for instance, a configuration example including a microcomputer having a processor (which serves as a central processing unit), ROM, RAM, etc. can be mentioned. By hardware included in control unit 4 and software executed by control unit 4, imaging control unit 41, illumination control unit 42, code detection unit 43, and decoding unit 44 are configured.

The code detection unit 43 of the control unit 4 is a part that identifies the code region based on the code image output from the imaging unit 3, and detects the code from the identified code region. The code detection unit 43 generates multiple edge images by applying multiple edge extraction filters for extracting edges of different frequencies to the image generated by the imaging unit 3, and then executes edge integration process for the multiple edge images. After that, the code detection unit 43 determines the code candidate position based on the result of the edge integration process. That is, in the edge processed image, a region where many pixels with large brightness values are concentrated can be estimated as the code region.

For example, the code detection unit 43 can generate a heatmap image representing code-likeness to search for the position of the code in the code image. That is, the code detection unit 43 quantifies the feature quantity of the code, generates a heatmap by assigning the magnitude of the feature quantity to each pixel value, and extracts a code candidate region where the possibility of code existence is high on the heatmap. As a specific example, there is a method of acquiring the feature part of the code in a region that is shown relatively hot (with large feature quantity) in the heatmap. When multiple feature parts are acquired, they can be prioritized for extraction and stored in RAM or the like. By using the heatmap image, it becomes possible to detect the code region at high speed.

The decoding unit 44 of the control unit 4 is a part that decodes the code detected by the code detection unit 43, and specifically, since the code is represented by black and white binarized data, it decodes the black and white binarized data. For decoding, a table showing the corresponding relationship of the encoded data can be used. Furthermore, the decoding unit 44 checks whether the decoded result is correct or not according to a predetermined check method. If an error is found in the data, the error correction function is used to calculate the correct data. The error correction function varies depending on the type of code.

As shown in FIG. 1, the code reader system S includes, in addition to the code reader 1, a dimension measuring unit 90, an encoder 91, a workpiece sensor 92, a data communication device 93, a controller 100, a data collection and analysis unit 200, a setting device 300, etc. The dimension measuring unit 90, controller 100, data collection and analysis unit 200, etc. are examples of external devices.

The setting apparatus 300 is configured with, for example, a personal computer or the like, and has a display unit (display device) 301 configured with a liquid crystal display or the like, and an operation unit 302 configured with various input devices or operation devices such as a keyboard and mouse. It is possible for a user to input various information by operating the operation unit 302. When the data collection and analysis unit 200 is a personal computer, the setting apparatus 300 need not be a personal computer, and may be a combination of a display and an input device.

The encoder 91 and workpiece sensor 92 are communicably connected to the controller 100 via IO wiring 94. The data communication device 93 is communicably connected to the controller 100 via host communication line 95, and is configured as a device that executes communication with external networks and the like. The code reader 1 and dimension measuring unit 90 are communicably connected to the controller 100 via dedicated control communication line 96.

The code reader 1 has an imaging unit 3 and a decoding unit 44, so the imaging unit 3 and the decoding unit 44 are connected to the controller 100. In addition, since the code reader 1 has an illumination unit 2 corresponding to the imaging unit 3, the illumination unit 2 is connected to the controller 100. In operation examples 1 and 2, imaging units 3 of the plurality of code readers 1, based on the installation information stored in a storage unit 112 (shown in FIG. 9) of the controller 100, receive instructions from a control unit 107 (shown in FIG. 9) of the controller 100, and capture the workpiece W from multiple different directions. The illumination units 2 of the plurality of code readers 1 receive instructions from the control unit 107 of the controller 100, and illuminate the workpiece W from multiple different directions. In other words, the imaging unit 3 and the illumination unit 2 are controlled by the control unit 107 of the controller 100.

Also, the code reader 1 and the dimension measuring unit 90 are connected to enable mutual communication via a dedicated control communication line 96. Furthermore, the code reader 1 is connected to enable communication with the data collection and analysis unit 200 via a communication line 97. The setting device 300 is connected to enable communication with the data collection and analysis unit 200 via a communication line 98, and is also connected to enable communication with the controller 100 via a communication line 99. The data collection and analysis unit 200 is a part that collects and stores time-series logs including images transmitted from the controller 100 and the code reader 1, and is typically a personal computer. The connection configuration of the aforementioned code reader 1, dimension measuring unit 90, encoder 91, workpiece sensor 92, data communication device 93, controller 100, data collection and analysis unit 200, and setting device 300 is one example, and any connection configuration that can realize the functions described later would be acceptable.

The dimension measuring unit 90 is composed of, for example, an optical dimension measuring instrument, and is an example of a detection sensor capable of detecting workpiece information including at least one of the position of the workpiece W in the width direction of the transport apparatus B and the height of the workpiece W. The optical dimension measuring instrument constituting the dimension measuring unit 90 can, for example, irradiate the workpiece W with measurement light, receive the measurement light reflected from the workpiece W, and measure the dimensions of the workpiece W based on the principle of triangulation. Examples of dimensions of the workpiece W that can be measured by the dimension measuring unit 90 include height, width, depth, etc. When the dimension measuring unit 90 receives a read start trigger signal transmitted from the controller 100 via a dedicated control communication line 96, it executes dimension measurement processing. The dimension measuring unit 90 transmits the generated dimension data to the controller 100 or the code reader 1 via the dedicated control communication line 96.

The encoder 91 is a device for detecting the conveyance speed of the transport apparatus B. As shown in FIG. 2, the encoder 91 is attached to the transport apparatus B. The workpiece sensor 92 is a device (for example, a photoelectric sensor) for detecting that the workpiece W transported by the transport apparatus B has reached a predetermined position, and outputs a detection signal when it detects that the workpiece W has reached the predetermined position. The workpiece sensor 92 can also be attached to the transport apparatus B. The workpiece sensor 92 is installed on the upstream side of the transport apparatus B relative to the imaging unit 3, and detects the workpiece W on the upstream side of the transport apparatus B relative to the imaging unit 3. Signals output from the encoder 91 and the workpiece sensor 92 are transmitted to the controller 100 via the IO wiring 94.

FIG. 6 is a diagram showing the positional relationships from the trigger point to the output point. The trigger point is a point where the read start trigger signal for executing image capture and illumination is output. For example, the point at which the workpiece sensor 92 detects that the workpiece W has reached a predetermined position can be set as the trigger point, and at the trigger point, the read start trigger signal can be output to the dimension measuring unit 90 and the code reader 1 via a dedicated control communication line 96. The workpiece sensor 92 is installed on the upstream side in the direction of conveyance relative to the code reader 1. Therefore, the code reader 1 will read the code attached to the workpiece W downstream of the workpiece sensor 92.

The dimension measuring unit 90 is installed at a dimension measuring unit installation point on the downstream side in the direction of conveyance from the trigger point. Therefore, it is possible to measure the dimensions of the workpiece W that arrives after the read start trigger signal is output. The code reader 1 is installed at a code reader installation point on the downstream side in the direction of conveyance from the dimension measuring unit installation point. Therefore, it is possible to capture an image of the workpiece W after it has been measured by the dimension measuring unit 90.

After the read start trigger signal is input, the decode processing of the code of the workpiece W will be executed, but this decode processing and the creation of output data including the decoding result, log, etc. are executed until the release point. When the workpiece W reaches the output point, the output data is output from the code reader 1 to the data communication device 93 via the dedicated control communication line 96.

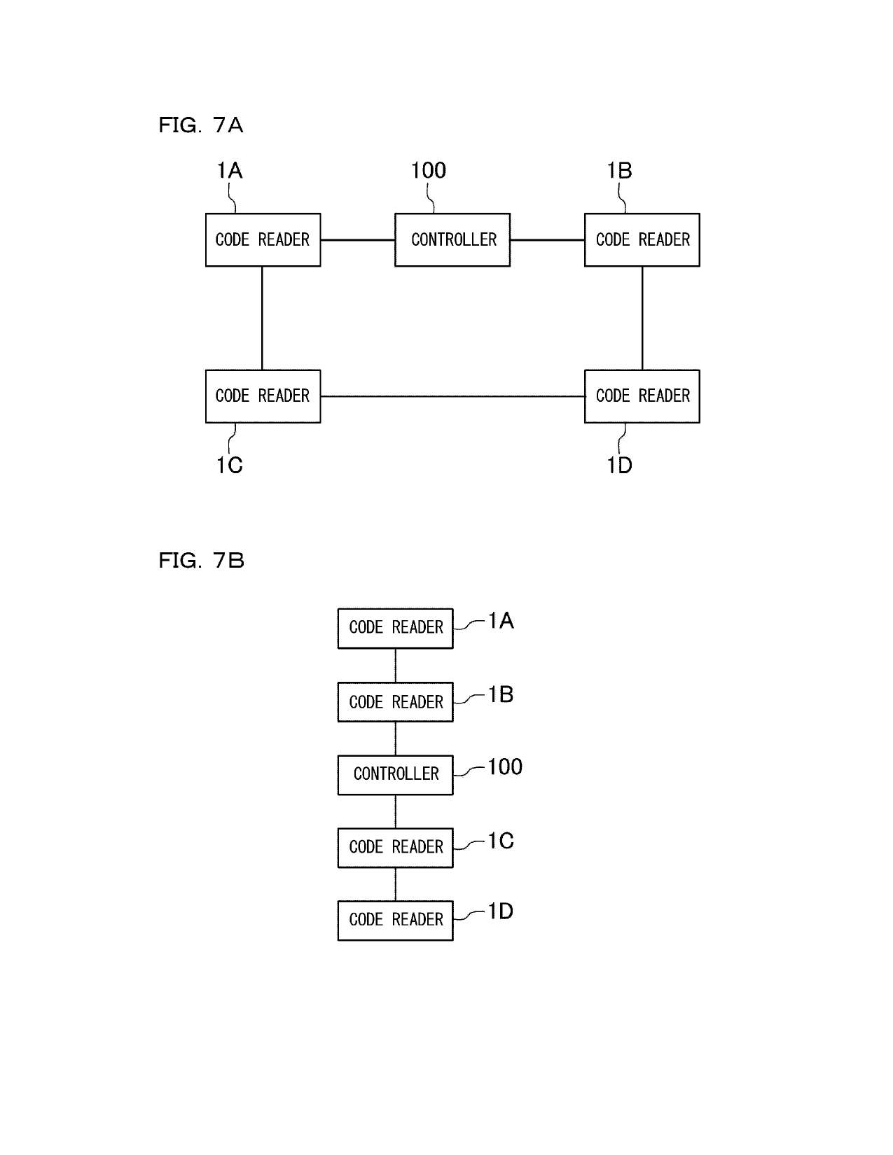

As shown in FIG. 7A, when operating multiple units of code readers 1A-1D, a camera network can be configured by connecting the controller 100 and multiple units of code readers 1A-1D in a ring formation. For the connection between the controller 100 and code reader 1A and code reader 1B, as well as the connections among code readers 1A-1D, Ethernet cables can be used, for example. By directly connecting multiple units of code readers 1A-1D to configure a camera network, even if the direct connection between a certain code reader 1 and the controller 100 is disconnected, the connection between that code reader 1 and the controller 100 can be maintained via other code readers 1.

Also, not limited to the configuration shown in FIG. 7A, as shown in FIG. 7B, when operating multiple units of code readers 1A to 1D, a camera network can be configured by connecting the controller 100 and multiple units of code readers 1A to 1D in a linear arrangement. In this case as well, for the connections between the controller 100 and code readers 1A to 1D, and between the code readers 1A to 1D themselves, Ethernet cables can be used, for example.

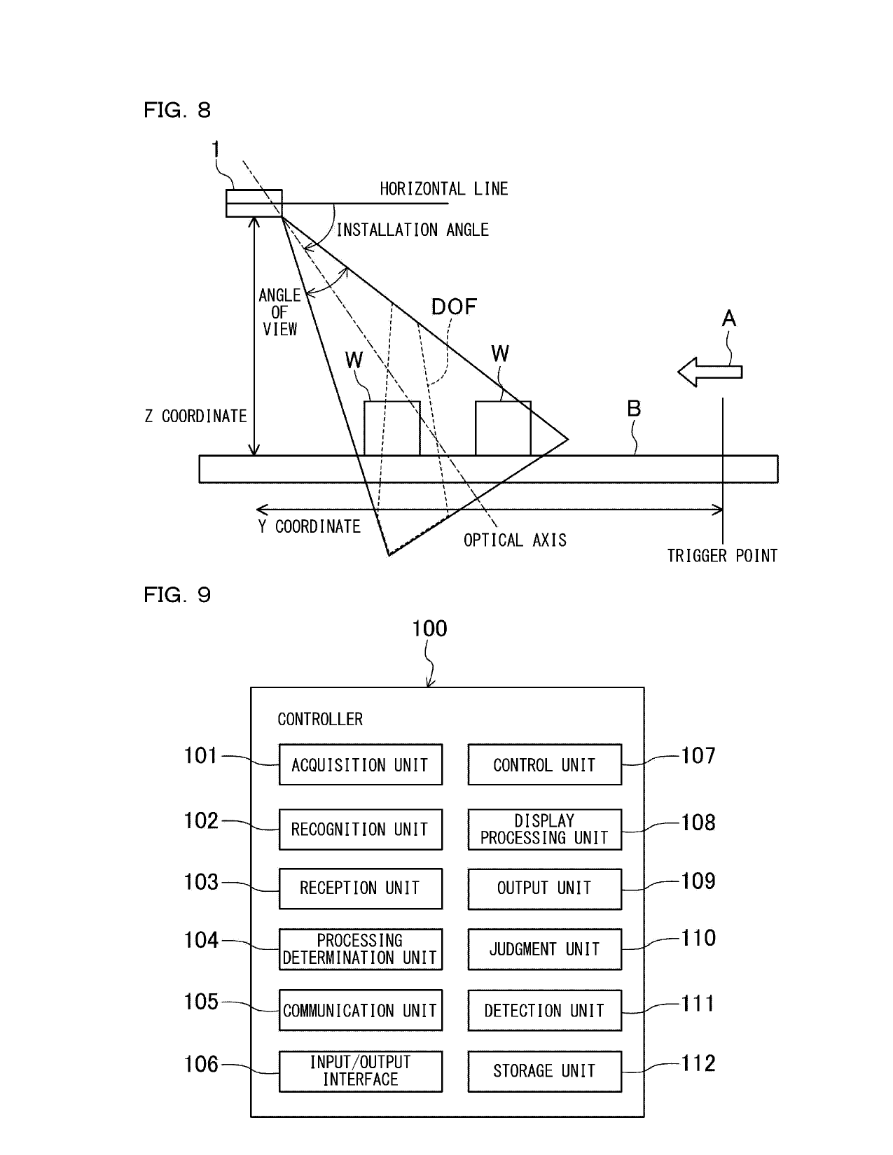

FIG. 8 is a diagram explaining the positional relationship between the code reader 1 and the transport apparatus B. The coordinate system of the transport apparatus B (conveyor coordinate system) can be defined, for example, with the position of the workpiece sensor 92 as the origin, the direction of conveyance as the Y direction, the width direction of the conveyor as the X direction, and the height direction from the transport surface as the Z direction. This is defined with reference to the position of the workpiece sensor 92. The installation angle of the code reader 1 is determined by the angle formed between the transport surface (Y direction) and the optical axis. The angle of view of the code reader 1 is predetermined for each model type of the code reader 1. The X coordinate, Y coordinate, Z coordinate, installation angle, installation direction, etc. of the code reader 1 are installation information indicating the position and posture of the imaging unit 3 in the conveyor coordinate system, and include the installation position and installation angle of the imaging unit 3 in the coordinate system of the transport apparatus B. The code reader 1 is equipped with an imaging unit 3 (camera) having a Scheimpflug optical system consisting of a lens 31a that collects reflected light from a code attached to the workpiece W and an image sensor 31b having a light receiving surface inclined with respect to the optical axis of the lens 31a, which generates and outputs an image containing the code based on the amount of light received on the light receiving surface. The imaging unit 3 has a depth of field DOF suitable for angled reading by means of the Scheimpflug optical system. The optical system of the imaging unit 3 is not limited to the Scheimpflug optical system.

Controller 100 is a device that comprehensively controls trigger control of code reader 1, dimension measuring unit 90, and external controlled equipment. When controller 100 receives signals output from workpiece sensor 92 that detects the position of workpiece W or encoder 91 for tracking workpiece W, it outputs control parameters and read start trigger signals etc. to code reader 1, dimension measuring unit 90, and external controlled equipment. In addition, it aggregates decode results from each code reader 1 and executes upload to data collection and analysis unit 200, setting device 300, etc.

The logic for trigger control includes delay settings from the time when the workpiece sensor 92 detects the workpiece W, and such settings are possible on the controller 100. In addition, processing of read data (such as string manipulation) can be executed on the controller 100. Therefore, the controller 100 has setting and programming elements, and is configured to be compatible with different upper-level communications (TCP/IP socket communication, legacy serial) protocol specifications according to the site where it is deployed.

Here, in the actual operation site, the installation locations of the code reader 1 vary, and it may be difficult to operate the code reader 1 and change the settings of the code reader 1 after installation. Also, setting individual IDs to each code reader 1 before installing multiple code readers 1 and then placing them in designated locations becomes a constraint on installation, and for example, if they are installed in the wrong location, it becomes difficult to reset the ID of that code reader 1. Furthermore, the person who installs the code reader 1 and the person who configures the code reader 1 may be different, and installation constraints should be eliminated as much as possible.

Also, the same applies to IP address, and the problems when installing the code reader 1 after setting in advance are as described above. Even after the code reader 1 has been installed, if the IP address is not set, DHCP can be used, but if a different IP address has already been assigned to the code reader 1, it cannot be handled unless it is returned to an unset state, so physical means such as an IP address initialization button becomes necessary. Furthermore, there are also use cases that do not use Ethernet (cases that do not require images), and it is necessary to make it possible to use the code reader 1 even when an IP address is not assigned to it.

In contrast to these issues, according to the dedicated control communication standard using the dedicated control communication line 96 of the present embodiment, ID allocation and IP address allocation to the code reader 1 via the dedicated control communication line 96 is possible, and control of the code reader 1 is also possible with only dedicated control communication. For example, after installation and wiring of the code reader 1 is completed, ID allocation to the code reader 1, which is a bus slave, can be performed from the controller 100, which is a bus master, via the dedicated control communication line 96. Additionally, after the dedicated control communication line 96 becomes communicable, IP addresses can be allocated to the code reader 1 via the dedicated control communication line 96 as needed, and setting information of the code reader 1 can be communicated.

The controller 100 and each code reader 1 are kept synchronized through a dedicated control system using dedicated control communication lines 96. The controller 100 generates a read start trigger signal and transmits the generated read start trigger signal to each code reader 1. The read start trigger signal can be changed according to the type of the code reader 1, for example, it may be an edge trigger or a level trigger. The edge trigger is one that triggers per unit of image capture, and the trigger instruction can include the target ID, capture time, control parameter, etc. The code reader 1 executes decoding targeting only one workpiece W in one image capture. On the other hand, the level trigger is one that triggers the start and stop of image capture, and the image capture timing is executed by the code reader 1.

When the controller 100 receives the read start trigger signal generated by the controller 100, each code reader 1 generates its own illumination timing according to its own time that is synchronization guaranteed. In other words, the controller 100 controls the ON and OFF of the illumination of each code reader 1.

Each code reader 1 performs image capture according to the illumination control timing. In operation example 1 shown in FIG. 2, the capture cycle of the code readers 1A and 1B other than the bottom reading depends on the period determined by the decoding time of the decoding unit 44, but in the case of the code reader 1C for bottom reading, image capture is performed at a constant cycle.

The specific configuration of the controller 100 will be explained based on FIG. 9. The controller 100 includes an acquisition unit 101, a recognition unit 102, a reception unit 103, a processing determination unit 104, a communication unit 105, an input-output interface 106, a control unit 107, a display processing unit 108, an output unit 109, a judgment unit 110, a detection unit 111, and a storage unit 112. The acquisition unit 101, the recognition unit 102, the reception unit 103, the processing determination unit 104, the communication unit 105, the input-output interface 106, the control unit 107, the display processing unit 108, the output unit 109, the judgment unit 110, the detection unit 111, and the storage unit 112 may be integrated or may be separate.

The input/output interface 106 is a portion to which the encoder 91, the workpiece sensor 92, the data communication device 93, the setting device 300, the code reader 1, the dimension measuring unit 90, an external controlled device, the data collection and analysis unit 200, and the like are connected. The input/output interface 106 is connected to the communication unit 105.

The acquisition unit 101 is a part that acquires detection signals of workpiece W by the workpiece sensor 92, conveyor information including conveyance speed and conveyor width of the transport apparatus B, and installation information indicating position and orientation of each code reader 1 in the conveyor coordinate system of the transport apparatus B. The conveyance speed of the transport apparatus B may be acquired based on the output signal of the encoder 91, or may be acquired from the moving distance in a predetermined time using multiple workpiece sensors, or may be acquired as the conveyance speed of the transport apparatus B set by the user. Note that, in cases where the encoder 91 calculates the transport distance of the workpiece based on the number of pulses during the elapsed time from when the workpiece W is detected until it is captured and the moving distance per unit pulse, it can be deemed that the conveyance speed is substantially or indirectly acquired, and the transport distance is determined based on the elapsed time and said conveyance speed.

The recognition unit 102 is a part that recognizes the transport status of the workpiece W on the transport apparatus B based on the detection signal and conveyance speed acquired by the acquisition unit 101. The transport status includes, for example, the conveyance speed and the position of the workpiece W on the transport apparatus B (that is, the position of the workpiece W in the conveyor coordinate system). The recognition unit 102 can further recognize the transport status including the dimensions of the workpiece W (width, height, depth) and the position and orientation of the workpiece W in the conveyor coordinate system by using information obtained from the dimension measuring unit 90.

The reception unit 103 is a portion configured to accept from a user a combination of code readers 1 among a plurality of code readers 1 connected to the controller 100, for which illumination interference should be prevented. For example, in the operation example 1 shown in FIG. 2, if the illumination of the upstream oblique reading code reader 1A and the downstream oblique reading code reader 1B were to turn on simultaneously, their illuminations would interfere with each other, possibly preventing the acquisition of desired code images. In cases where such illumination interference needs to be prevented, the combination of code reader 1A and code reader 1B becomes the combination of code readers 1 for which illumination interference should be prevented. When a user specifies code reader 1A and code reader 1B, this combination is accepted by the reception unit 103.

The processing decision unit 104 acquires the transport status of the workpiece W recognized by the recognition unit 102 and the installation information of each code reader 1 acquired by the acquisition unit 101. The installation information may include information about combinations of code readers 1 for which illumination interference prevention is desired. The processing decision unit 104 determines control parameters corresponding to a predetermined transport position of the workpiece W on the transport apparatus B for each code reader 1, based on the transport status of the workpiece W and the installation information of each code reader 1. The processing decision unit 104 can estimate the current position of the workpiece W based on the output signal of the encoder 91 and the detection signal of the workpiece sensor 92. The processing decision unit 104 determines the control parameters in advance before the workpiece W reaches the predetermined transport position on the transport apparatus B. In other words, since it is possible to acquire the transport status indicating what kind of workpiece W is currently located where, optimal control parameters for each code reader 1 can be updated and prepared in advance. Then, when each code reader 1 becomes capable of capturing images, each code reader 1 executes illumination and image capture control using the latest control parameters at that time. The code reader 1 is not limited to a configuration having one imaging unit 3 as shown in FIG. 5, but may have a configuration with multiple imaging units 3 inside the housing of the code reader 1. Also, the code reader 1 is not limited to a configuration having both the imaging unit 3 and the decoding unit 44 inside the housing, but the decoding unit 44 may be provided as a separate device. In these configurations, the processing decision unit 104 determines control parameters corresponding to a predetermined transport position of the workpiece W on the transport apparatus B for each imaging unit 3, based on the transport status of the workpiece W and the installation information of each imaging unit 3.

The control parameters determined by the process determination unit 104 include, for example, the exposure time of the imaging unit 3, gain, types of codes to be decoded, read result output timeout, capture range (imaging range of the image sensor 31b), processing parameters by the preprocessing circuit 32, etc. The exposure time can be determined according to the conveyance speed of the transport apparatus B acquired based on the output signal of the encoder 91. For example, the faster the conveyance speed, the shorter the exposure time can be set. By having the process determination unit 104 automatically optimize the exposure time, the brightness of the image generated by the imaging unit 3 becomes suitable for decode processing. Also, the gain is the gain of the imaging unit 3, and based on the position of the workpiece W on the transport apparatus B and the installation information of the code reader 1, the process determination unit 104 automatically sets it to the optimal value. By optimizing the gain, the brightness of the image generated by the imaging unit 3 becomes suitable for decode processing.

The processing determination unit 104 is configured to determine the code to be read as a control parameter for each capture cycle based on the transport status of the workpiece W and the installation information of each code reader 1. The type of code to be decoded refers to the type of code that the decoding unit 44 decodes, and multiple types can be specified. For example, the processing determination unit 104 determines the type of code to be decoded as a control parameter in cases such as excluding codes that do not need to be read based on the reading results of another code reader 1 installed on the upstream side, or switching the code to be read for each image capture. Additionally, it is possible to determine the control parameters such that a first type of code is read by a first code reader 1 on the upstream side in the direction of conveyance, and a second type of code is read by a second code reader 1 on the downstream side.

The communication unit 105 is a part that executes communication with a plurality of code readers 1 according to a dedicated control communication standard, and transmits the control parameters determined by the processing decision unit 104 to the corresponding code readers 1. For example, the communication unit 105, after the control parameters corresponding to the code reader 1 have been determined, transmits the corresponding control parameters to each code reader 1 at the timing when the workpiece W reaches a predetermined transport position.

In the case where a plurality of code readers 1 are connected, the communication unit 105 transmits the capture cycle determined by the processing decision unit 104 to each corresponding code reader 1, and transmits the illumination cycle determined by the processing decision unit 104 to each corresponding code reader 1. The preprocessing circuit 32 can execute processing before image capture and processing after image capture according to the control parameter.

### Initial Setting

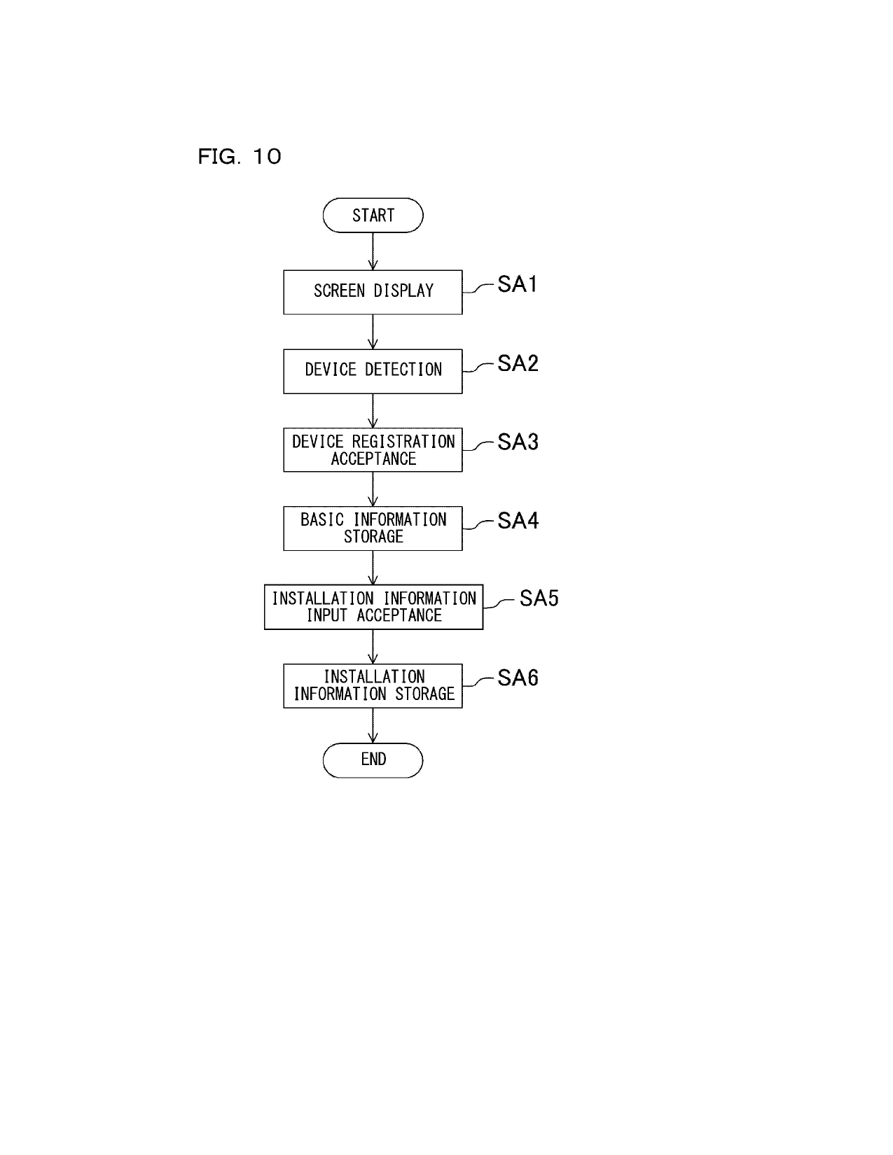

Next, the procedure for the initial setting of the code reader system S configured as described above will be explained based on the flowchart shown in FIG. 10. This flowchart starts, for example, immediately after the code reader system S is started for the first time, after changing the installation position of the code reader 1, after changing various devices, etc.

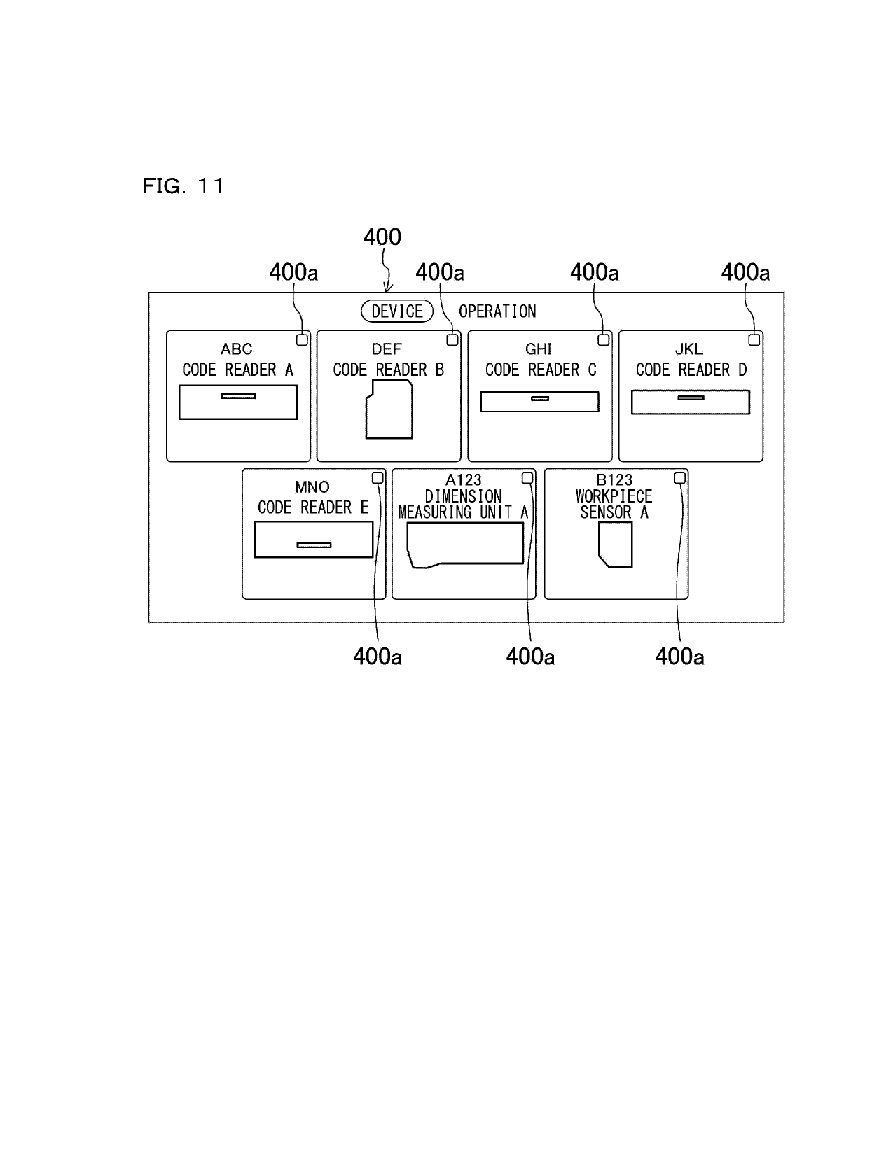

In step SA1, the display processing unit 108 of the controller 100 displays a device display screen 400 as shown in FIG. 11 on the display unit 301 of the setting apparatus 300. In step SA2, the control unit 107 of the controller 100 detects devices connected to the controller 100. Examples of devices connected to the controller 100 include the code reader 1, the dimension measuring unit 90, the workpiece sensor 92, etc., but are not limited to these, and other devices may also be connected to the controller 100.

When a device connected to the controller 100 is detected in step SA2, the detected device is displayed on the device display screen 400. In the example shown in FIG. 11, a case where code reader A, code reader B, code reader C, code reader D, code reader E, dimension measuring unit A, and workpiece sensor A are detected is shown. As shown in this FIG. 11, on the device display screen 400, illustrations or photographs of each device are displayed, along with the name and model type of each device.

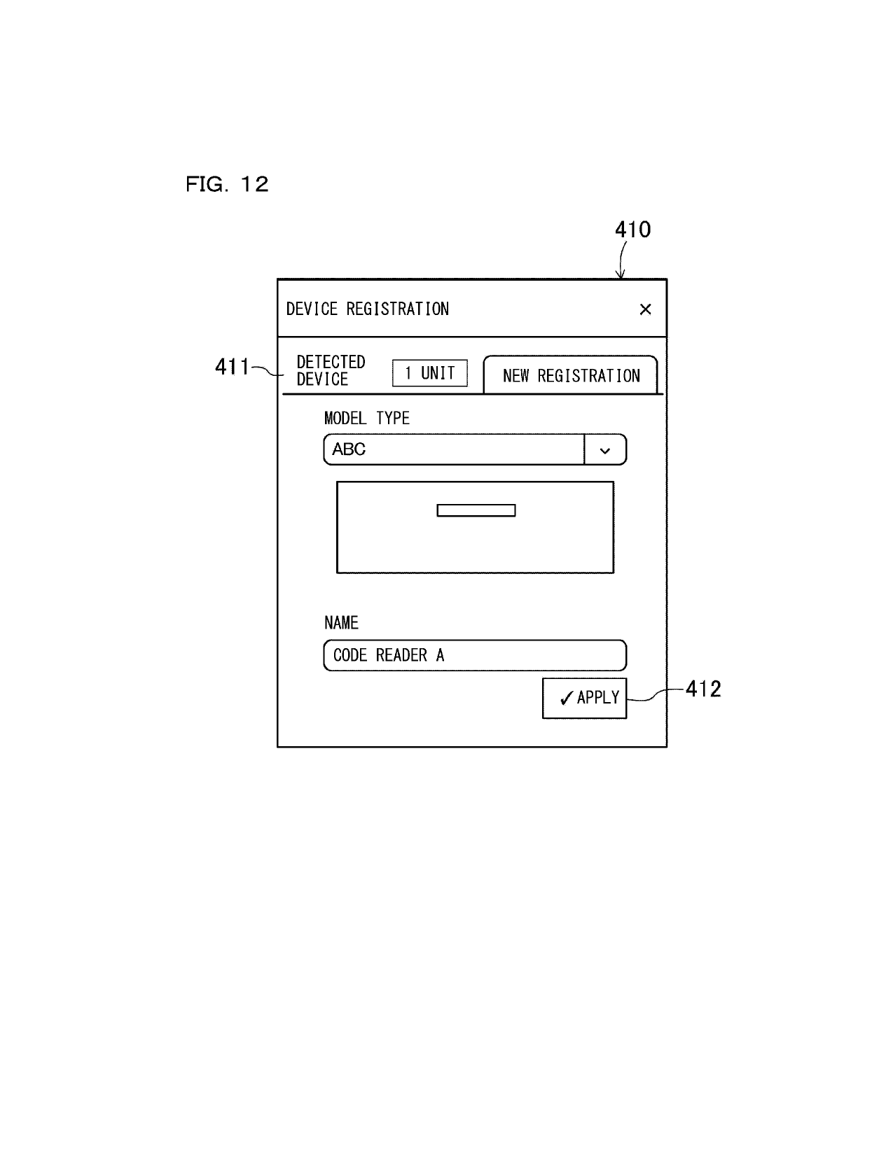

In step SA3, a registration reception of the device detected in step SA2 is performed. When a user performs an operation to select a device that the user wants to register from among the devices displayed on the device display screen 400 shown in FIG. 11, the display processing unit 108 generates a device registration screen 410 shown in FIG. 12 and displays it on the display unit 301. When code reader A is selected, the device display region 411 provided in the device registration screen 410 displays the model type of code reader A, an illustration or photograph of code reader A, and the name (code reader A). When the apply button 412 is operated by the user, the device displayed in the device display region 411 is registered by the control unit 107 of the controller 100.

The device display screen 400 shown in FIG. 11 is provided with icons 400a indicating whether each device is registered or not, corresponding to each device. The user can easily grasp whether the device corresponding to the icon 400a is registered or not by looking at the icon 400a. Note that steps SA2 and SA3 may be performed in reverse order, and the detected device may be allocated after registering the device.

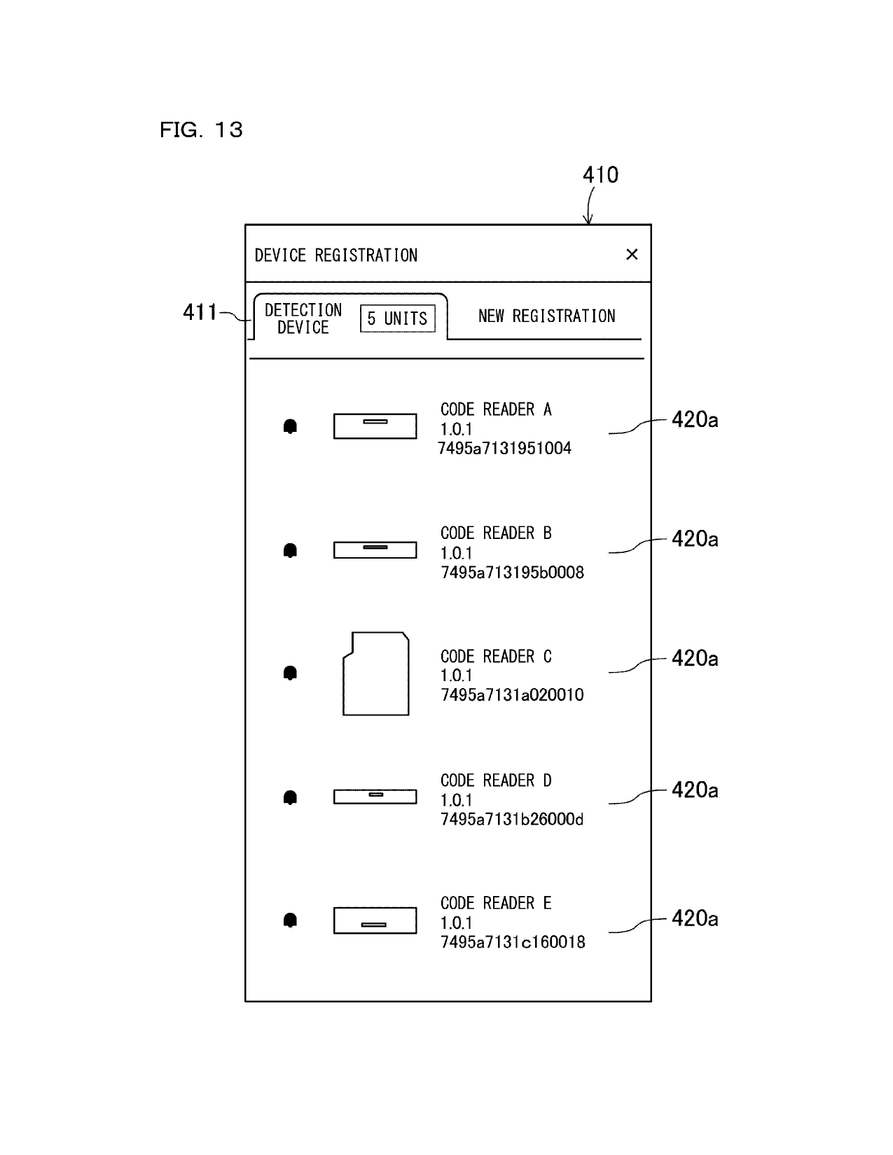

FIG. 13 shows a display screen 420 of registered devices, which is generated by the display processing unit 108 and displayed on the display unit 301. In this example, five code readers A to E are registered devices. The display processing unit 108 generates a screen that can display a list of registered devices. The display screen 420 includes ID display regions 420a for displaying device IDs for each registered device. The device ID is a value that has uniqueness and also allows for model type identification of the registered device. The association between registered device information and equipment can be performed using this device ID.

After the registration of necessary devices is completed, the process proceeds to step SA4, and the basic information of the registered devices is stored in the storage unit 112 of the controller 100. The basic information includes, for example, the identification number of the device (serial number, MAC address, device ID), the node position in the system, model type, etc., which are associated with the device. The node position in the system is dynamically detected based on the controller 100 as a reference for the physical position of each registered device at system startup, and the detection unit 111 retains the node position when detecting the physical position of each registered device. For example, when the controller 100 and multiple code readers 1A to 1D are connected in a ring shape as shown in FIG. 7A, and when the controller 100 and multiple code readers 1A to 1D are connected in a straight line as shown in FIG. 7B, focusing on the same code reader 1A results in different node positions, but the node positions of each code reader 1A to 1D are updated at the timing when the detection unit 111 of the controller 100 detects the change in the node position. Then, the updated node position is stored in the storage unit 112. In other words, the detection unit 111 is a part that can detect one or more connected code readers 1A to 1D and store the node position of the detected code readers 1A to 1D in the camera network in the storage unit 112. Furthermore, the detection unit 111 is a part that can detect one or more connected code readers 1A to 1D again and overwrite and store the node position of the re-detected code readers 1A to 1D in the camera network in the storage unit 112.

In step SA5, the control unit 107 of the controller 100 accepts the input of installation information. As shown in FIG. 8, in the case of the code reader 1, the installation information includes at least one of the X coordinate, Y coordinate, Z coordinate, installation angle, and installation direction of the imaging unit 3 in the coordinate system of the transport apparatus B. The installation direction indicates whether the code reader 1 is installed on the upstream side of the transport direction to read the rear surface of the workpiece W, or the code reader 1 is installed on the downstream side of the transport direction to read the front surface of the workpiece W. The coordinate system of the transport apparatus B is defined based on the position of the workpiece sensor 92 that detects the workpiece W on the upstream side of the transport apparatus B relative to the one or more imaging units 3. In addition, the installation information may further include the surface of the plurality of surfaces of the workpiece W that is read by the corresponding imaging unit 3. The installation information may include network information such as an IP address, and this network information may be stored in association with the device ID.

In step SA6, the installation information of each registered device accepted as input in step SA5 is stored in the storage unit 112 of the controller 100. In this step, the device installation information and the device ID are stored in an associated state. Therefore, for example, by identifying a device, it is possible to obtain not only the basic information associated with that device ID but also the installation information. When step SA6 is completed, the operation of the code reader system S becomes possible.

During the operation of the code reader system S, there are cases where, for example, the code reader 1 malfunctions or maintenance of the code reader 1 becomes necessary. In such cases, the code reader 1 is removed and a new code reader 1 is connected to the code reader system S to resume operation, but if the installation information can be quickly reflected in the new code reader 1 after replacement, the downtime of the code reader system S can be shortened, making it possible to suppress losses. In this embodiment, a function is installed that allows installation information to be quickly reflected in the new code reader 1 after replacement to shorten the downtime of the code reader system S.

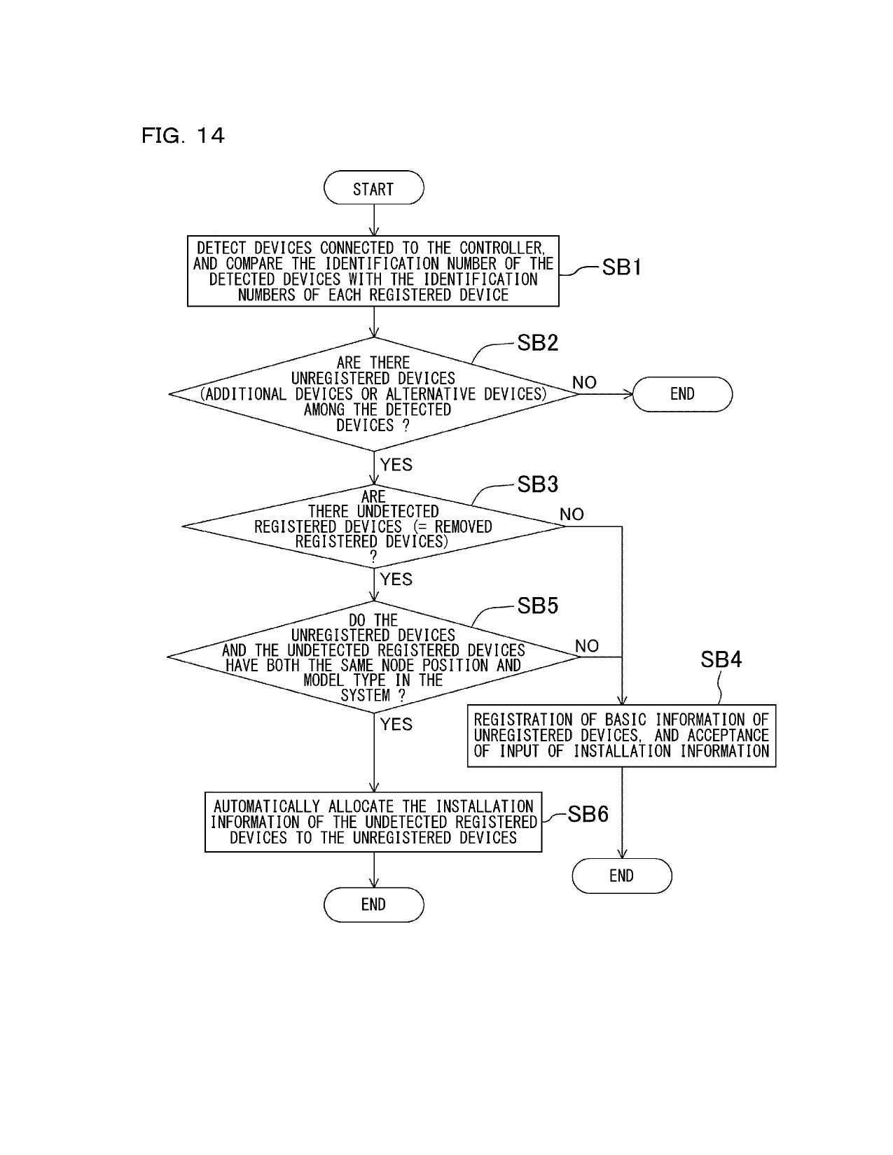

Specifically, this will be explained based on the flowchart shown in FIG. 14. This flowchart may start after operating the code reader system S and then connecting a new code reader 1 and starting the code reader system S, or it may start periodically. It should be noted that it is possible to replace the code reader 1 without turning off the power of the controller 100, and in that case, the flowchart shown in FIG. 14 can also be started after the replacement of the code reader 1 is completed. The flowchart shown in FIG. 14 may also be started by user instruction.

In step SB1, the detection unit 111 detects devices connected to the controller 100 and compares the identification number of the detected device with the identification numbers of each registered device registered in the flowchart shown in FIG. 10. In step SB2, the detection unit 111 determines whether there is an unregistered device among the detected devices. Unregistered devices may be, for example, devices added to the code reader system S or new devices (alternative devices) that have been replaced. When each device is a code reader 1, since the code reader 1 includes an imaging unit 3, step SB2 is a process for detecting the removal of any one of one or more imaging units 3 whose installation information is stored in the storage unit 112 of the controller 100, and the connection of a new imaging unit 3 different from the one or more imaging units 3. In this process, the detection unit 111 detects the removal of any one of one or more imaging units 3 whose installation information is stored in the storage unit 112 of the controller 100, and the connection of a new imaging unit 3 different from the one or more imaging units 3.

If there are no unregistered devices among the detected devices, the process proceeds to the end and terminates this flowchart. On the other hand, if there are unregistered devices among the detected devices, the process proceeds to step SB3. In step SB3, the detection unit 111 determines whether there are any undetected devices. If NO is determined in step SB3 and there are no undetected devices, this means that there are only new devices added and no devices have been removed, so the process proceeds to step SB4, where registration of basic information for unregistered devices and input of installation information are accepted. In step SB4, the registration unit notifies the user with the icon 400a shown in FIG. 11 that not all units are fully registered. In this case, the registration of basic information for unregistered devices and input of installation information can be accepted according to the flowchart shown in FIG. 10 described above.

When step SB3 is determined to be YES and there is an undetected device, it means that the device has been replaced, and the process proceeds to step SB5. In step SB5, the judgment unit 110 determines whether both the node position and the model type in the system are the same for the unregistered device and the undetected registered device. That is, the judgment unit 110 executes a replacement judgment on whether the new imaging unit 3 is suitable for replacement of the removed imaging unit 3 based on the node position of each imaging unit 3 in the camera network composed of one or more imaging units 3, and the model type of each imaging unit 3. When the judgment unit 110 executes the replacement judgment, it may be executed based on the node position, the model type, and the output of the accelerometer 33. When the imaging unit 3 is replaced with a new one, the output of the accelerometer 33 will have similar values before and after the replacement, which further improves the accuracy of the replacement judgment.

Here, in an actual operating environment, if a device fails, it is generally assumed that a substitute device of the same model type as the failed device will be used. Therefore, when a different model type is detected in step SB5, the system proceeds to step SB4 and determines that the configuration or layout of the code reader system S has been changed, thus preventing it from being detected as a substitute device. That is, the judgment unit 110 executes a replacement judgment in step SB5 to determine whether the newly detected imaging unit 3 is suitable for replacing the removed imaging unit 3. Even if the model type or node position differs between the failed device and the substitute device, if the new imaging unit 3 that will serve as the substitute device can be allowed to capture images of the workpiece W based on the installation information of the imaging unit 3 that was removed as the failed device, step SB5 may be omitted.

In Step SB5, when it is determined that both the node position and model type within the system are the same for an unregistered device and an undetected registered device, the process proceeds to Step SB6. In Step SB6, the control unit 107 automatically allocates the installation information of the undetected registered device to the unregistered device. Specifically, when the determination unit 110 determines that a new imaging unit 3 is suitable for replacement of a removed imaging unit 3, the control unit 107 uses the installation information of the removed imaging unit 3 as the installation information for the new imaging unit 3. As a result, the control unit 107 determines the image capture conditions for the workpiece W for the new imaging unit 3 based on the installation information of the removed imaging unit 3, so the image capture conditions for the new imaging unit 3 are determined based on the installation information of the removed imaging unit 3. At this time, the control unit 107 may instruct the new imaging unit 3 to capture an image of the workpiece W, or the new imaging unit 3 may execute the image capture by itself based on the capture conditions determined by the control unit 107. The capture conditions include at least one of capture timing, the range or position of the region to be partially captured within the overall field of view of the camera, exposure time, gain, and regions within the captured image that are excluded from decoding.

In step SB6, notification may be made that the installation information of the removed imaging unit 3 has been applied as the installation information for the new imaging unit 3. That is, as shown in FIG. 5, the code reader 1 has a notification unit 34 for notifying that the installation information of the removed imaging unit 3 has been applied as the installation information for the new imaging unit 3. The notification unit 34 is connected to the control unit 4 and is controlled by the control unit 4. Examples of the notification unit 34 include light-emitting bodies such as LEDs and various speakers. When the notification unit 34 is a light-emitting body, as shown in one example in FIG. 3, it can be provided on the housing of the code readers 1A to 1F. When the notification unit 34 is a light-emitting body, the control unit 4 can notify the user by causing the light-emitting body to emit light in step SB6. The emission form such as the emission color, emission time, emission timing, flashing interval, illumination time, etc. of the light-emitting body can be set arbitrarily, and it should be an emission form that allows the user to recognize that the process of step SB6 has been executed.

For example, if the code reader 1A fails, the notification unit 34 of the code reader 1A notifies the user that the code reader 1A has failed by red flashing or the like. Also, when the controller 100 recognizes the failed code reader 1A as a replacement target, the notification unit 34 notifies the user that the replacement target has been recognized by blue flashing or the like. Then, when the replacement of the code reader 1A is completed and the process of step SB6 is executed, the notification unit 34 illuminates a blue color for a predetermined time. This allows the user to be notified in an easily understandable manner that the installation information of the removed imaging unit 3 has been applied as the installation information for the new imaging unit 3.

Further, when the notification unit 34 is a speaker, the control unit 4 can notify the user by causing the speaker to generate sound in step SB6. The tone, sound generation time, sound generation timing, etc. of the speaker can be arbitrarily set. By having the notification unit 34 as described above, the user can confirm that the replacement has been properly completed without opening the setting screen.

In step SB6, a setting screen may be displayed on the display unit 301 in a manner that distinguishes between a new imaging unit 3 that replaces the removed imaging unit 3 and the other imaging units 3 among one or more imaging units 3. That is, the display processing unit 108 of the controller 100 can generate a setting screen and display it on the display unit 301, and the setting screen is configured to be capable of displaying in a manner that distinguishes between a new imaging unit 3 that replaces the removed imaging unit 3 and the other imaging units 3 among one or more imaging units 3. The distinguished manner includes displaying the new imaging unit 3 and the other imaging units 3 in different colors, enclosing them with frames of different colors, attaching different icons, displaying messages, etc., but is not limited to these.

In the present embodiment, the controller 100 can control the code readers 1A-1F in real time. The controller 100, which controls the code readers 1A-1F in real time, centrally manages the installation information of each code reader 1A-1F, and the controller 100 distributes the installation information to its target devices, which is a hierarchical format adopted by the code reader system S. As a result, settings are appropriately reflected between devices constituting the code reader system S, enabling high real-time setting reflection.

In contrast, for example, a configuration could be considered where setting information is centrally managed in an external storage other than the controller, and each device refers to that setting, but with this configuration, if inconsistencies occur in the settings of each device due to temporary communication interruptions, the devices cannot follow setting changes in real-time, and there is a possibility of setting discrepancies occurring between devices. As a result, there would be significant disadvantages from the perspectives of efficiency and responsiveness.

By having the controller 100 retain setting information as in this embodiment, there is no need to acquire setting information via a network, and by consolidating all device information, MTTR (Mean Time To Repair/Recovery: time taken to recover from a failure) can be minimized. Particularly in logistics applications, since quick setting recovery is important, the effect of minimizing MTTR becomes even more significant.

The above-described embodiments are merely exemplary in all aspects and should not be interpreted in a limiting manner. Furthermore, all modifications or changes belonging to the equivalent scope of the claims are within the scope of the present invention.

### INDUSTRIAL APPLICABILITY

As described above, the technology according to the present disclosure can be used, for example, in logistics sites and the like.

What is claimed is:

1. A code reader system, comprising one or more cameras that generate an image based on reflected light from a code attached to a workpiece being transported on a conveyor,
a decoder that executes a decode processing of the code attached to the workpiece based on images output from the one or more cameras, and
a controller to which the one or more cameras and the decoder are connected,
wherein the controller comprises:
a storage unit that stores installation information of each of the one or more cameras,
a control unit that determines imaging conditions of the one or more cameras based on the installation information stored in the storage unit, and
a detection unit that detects removal of any of the one or more cameras whose installation information is stored in the storage unit, and connection of a new camera different from the one or more cameras,
wherein imaging conditions of the new camera are determined based on the installation information of the removed camera.

2. The code reader system according to claim 1,
wherein the control unit instructs the new camera to capture an image of the workpiece based on the installation information of the removed camera.

3. The code reader system according to claim 1, further comprising a judgment unit that performs an exchange judgment of whether the new camera is suitable for replacement of the removed camera,
wherein the control unit uses the installation information of the removed camera as installation information of the new camera when the judgment unit determines that the new camera is suitable for replacement of the removed camera.

4. The code reader system according to claim 3, wherein
the judgment unit executes the exchange judgment based on node positions of each camera in a camera network constituted by the one or more cameras, and model types of each camera.

5. The code reader system according to claim 4, wherein
the one or more cameras has an accelerometer, and
the judgment unit executes the exchange determination based on the node positions, the model types, and an output of the accelerometer.

6. The code reader system according to claim 4,
wherein the detection unit, upon detecting the one or more cameras connected, stores a node position of the detected camera in the camera network in the storage unit.

7. The code reader system according to claim 6,
wherein, when the detection unit detects again the one or more cameras connected, the detection unit overwrites and stores the node position of the detected camera in the camera network in the storage unit.

8. The code reader system according to claim 1, wherein
the one or more cameras has a notification unit, and
the notification unit notifies that the installation information of the removed camera has been applied as installation information of the new camera.

9. The code reader system according to claim 1,
wherein the installation information includes at least one of an installation position, installation angle, and installation direction of the one or more cameras in a coordinate system of the conveyor.

10. The code reader system according to claim 9,
wherein the installation information further includes a surface among surfaces of the workpiece that is read by a corresponding camera.

11. The code reader system according to claim 9,
wherein the coordinate system of the conveyor is defined based on a position of a sensor that detects the workpiece on an upstream side of the conveyor relative to the one or more cameras.

12. The code reader system according to claim 1, wherein
the controller further comprises a display processing unit that generates a setting screen that displays the new camera after the removed camera has been replaced and the other cameras in a distinguishable manner.

13. A controller connected to one or more cameras that generate images based on reflected light from a code attached to a workpiece conveyed on a conveyor, and a decoder that executes decode processing of the code attached to the workpiece based on the images output from the one or more cameras, the controller comprising:
a storage unit that stores installation information of each of the one or more cameras;
a control unit that determines imaging conditions of the one or more cameras based on the installation information;
a detection unit that detects removal of any of the one or more cameras whose installation information is stored, and connection of a new camera different from the one or more cameras,
wherein the control unit determines imaging conditions for the workpiece for the new camera based on the installation information of the removed camera.

14. The controller according to claim 13,
wherein the control unit instructs the new camera to capture an image of the workpiece based on the installation information of the removed camera.

15. The controller according to claim 13, further comprising a judgment unit that performs an exchange judgment of whether the new camera is suitable for replacement of the removed camera,
wherein the control unit uses the installation information of the removed camera as installation information of the new camera when the judgment unit determines that the new camera is suitable for replacement of the removed camera.

16. The controller according to claim 15, wherein
the judgment unit executes the exchange judgment based on node positions of each camera in a camera network constituted by the one or more cameras, and model types of each camera.

17. The controller according to claim 16,
wherein the detection unit, upon detecting the one or more cameras connected, stores a node position of the detected camera in the camera network in the storage unit.

18. The controller according to claim 13,
wherein the installation information includes at least one of an installation position, installation angle, and installation direction of the one or more cameras in a coordinate system of the conveyor.

19. The controller according to claim 18,
wherein the coordinate system of the conveyor is defined based on a position of a sensor that detects the workpiece on an upstream side of the conveyor relative to the one or more cameras.

20. The controller according to claim 1, further comprising a display processing unit that generates a setting screen that displays the new camera after the removed camera has been replaced and the other cameras in a distinguishable manner.
